(19) United States
(12) Patent Application Publication
(10) Pub. No.: US 2026/0154690 A1
(43) Pub. Date: Jun. 4, 2026

(54) DATA-DRIVEN SYSTEMS AND METHODS FOR GENERATING DAY-BY-DAY DIARIES OF VEHICLE USAGE FOR DURABILITY AND RELIABILITY ASSESSMENTS

(71) Applicant: Rivian IP Holdings, LLC, Irvine, CA (US)

(72) Inventors: Sankaran Ramakrishnan, Foster City, CA (US); Dr. Prashant Dilip Khapane, Irvine, CA (US)

(21) Appl. No.: 19/376,197

(22) Filed: Oct. 31, 2025

Related U.S. Application Data
(60) Provisional application No. 63/726,465, filed on Nov. 29, 2024.

(51) Int. Cl. G06Q 30/012

(52) U.S. Cl. CPC G06Q 30/012

(57) ABSTRACT

The system generates a travel diary for each user profile of a plurality of user profiles based on a plurality of travel patterns, drive cycle information of a vehicle type, and charging information to result in a plurality of travel diaries. The system generates a plurality of load histories corresponding to a vehicle component of the vehicle type based on the plurality of travel diaries, and determines a distribution of a load parameter. The distribution is used to update vehicle information. For example, the distribution may be used to tune or verify a design parameter, a testing parameter, a service parameter, or a warranty parameter, for example.

### CROSS-REFERENCE TO RELATED APPLICATIONS

This application claims the benefit of U.S. Provisional Patent Application No. 63/726,465, filed Nov. 29, 2024, the disclosure of which is hereby incorporated by reference herein in its entirety.

### INTRODUCTION

The present disclosure is directed to generating travel diaries of vehicle usage for durability and reliability assessments.

### SUMMARY

In some circumstances, stress factors, including tractive loads, electrical loads, thermal loads, and structural loads factor into vehicle design and durability. For electric vehicle propulsion systems, for example, the present disclosure may be applied to analyze the magnitude and repetition of these loads, and their time history throughout a lifespan of the vehicle. The sequence, timing, and characteristics of these loads over the lifespan may influence factors such as charge and discharge cycles, active motor heating, and damage to propulsion system components (e.g., batteries, inverter). In some embodiments, rather than rely only on a single-user load profile having representative drive cycles accounting for the cumulative damage equivalent to the real-world damage covered under warranty, the present disclosure uses high-fidelity, cloud-based vehicle data, allowing a representative population to be generated that accurately reflects the frequency, type, and sequence of real-world driving, parking, and charging loads. In some embodiments, the method and systems of the present disclosure integrate reference information (e.g., vehicle-measured data, survey data, and test data) to model user travel patterns, driving profiles, and charging behaviors. In some embodiments, the present disclosure is directed to generating lifetime vehicle usage patterns for a diverse set of users and identify warranty-critical damage for one or more components or systems of the vehicle. For example, the warranty-critical damage for each component might occur in a different subset of users, thus the overall population covers the durability loads for the entire propulsion system or the vehicle.

In some embodiments, the present disclosure is directed to methods for generating load histories for use in design, testing, servicing, and warranty analysis. The methods may be performed by processing equipment based on computer instructions stored in non-transitory computer-readable medium. The methods include generating a travel diary for each user profile of a plurality of user profiles based on a plurality of travel patterns, drive cycle information of a vehicle type, and charging information to result in a plurality of travel diaries. The methods also include generating a plurality of load histories corresponding to a vehicle component of the vehicle type based on the plurality of travel diaries, and determining a distribution of a load parameters based on the plurality of load histories. In some embodiments, generating the travel diary for each user profile of the plurality of user profiles includes generating a travel pattern for each user profile to result in the plurality of travel patterns corresponding to the vehicle type, generating a drive history for each user profile based on the plurality of travel patterns and based on drive cycle information of the vehicle type to result in a plurality of drive histories, and generating the charging information based on the travel pattern and the drive history for each user profile. In some embodiments, the methods include determining the plurality of user profiles based on a plurality of predetermined user archetypes corresponding to a target customer base. In some embodiments, the methods include generating the plurality of travel patterns based on a stochastic, multi-year model. In some embodiments, the plurality of user profiles is a first plurality of user profiles, and the methods include determining a second plurality of user profiles, and repeating generating the travel diary for each user profile and generating the plurality of load histories based on the second plurality of user profiles. In some embodiments, each travel diary includes a respective plurality of trips, and generating the plurality of load histories includes applying a load model to each respective plurality of trips.

In some embodiments, the methods include determining an estimated life of the vehicle component based on the plurality of load histories and vehicle component information. In some embodiments, the methods include identifying a subset of user profiles of the plurality of user profiles corresponding to an attribute, wherein a subset of travel diaries of the plurality of travel diaries correspond to the subset of user profiles. In some such embodiments, the methods include identifying a target stress corresponding to the vehicle component based on the subset of travel diaries, and determining at least one of a design parameter, a testing parameter, a service parameter, or a warranty parameter based on the target stress. In some embodiments, the methods include generating, based on the plurality of load histories or the distribution, a design parameter for the vehicle component, and making the vehicle component based on the design parameter. In some embodiments, the methods include generating, based on the plurality of load histories or the distribution, a testing parameter for the vehicle component, applying test conditions to the vehicle component based on the testing parameter, and recording data corresponding to a response of the vehicle component to the test conditions. In some embodiments, the methods include generating, based on the plurality of load histories or the distribution, a servicing parameter for the vehicle component, and scheduling a service of the vehicle component based on the servicing parameter. In some embodiments, the methods include modifying, based on the plurality of load histories or the distribution, at least one of (i) a design parameter of the vehicle component or (ii) a testing parameter for the vehicle component. In some embodiments, the methods include determining, based on the plurality of load histories, warranty information corresponding to the vehicle component, and generating a warranty notification based on the warranty information. For example, the warranty information includes a target warranty life of the vehicle type, and each of the plurality of travel diaries spans the target warranty life. In some embodiments, the methods include determining a remaining life of the vehicle component based on the plurality of load histories, and generating an indication of the remaining life at a user interface. In some embodiments, the methods include updating, in memory storage of a vehicle of the vehicle type, a threshold value corresponding to the plurality of load histories. In some embodiments, the methods include receiving updated information corresponding to the vehicle component, and updating the plurality of load histories based on the updated information. In some embodiments, the methods include generating a usage distribution for one or more loads based on the plurality of travel diaries. In some embodiments, the methods include generating a damage distribution for one or more loads based on the plurality of travel diaries and a damage model. In some embodiments, the plurality of load histories includes a damage distribution for the plurality of travel patterns, and the methods include determining the damage distribution based on the plurality of travel patterns and reference information corresponding to the vehicle component.

In some embodiments, the present disclosure is directed to systems for generating load histories for use in design, testing, servicing, and warranty analysis. The systems may be implemented by processing equipment based on computer instructions stored in non-transitory computer-readable medium, where the computer instructions are executable by the processing equipment to perform any of the methods described above.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 is a block diagram of an illustrative system for managing population information for usage dynamics, in accordance with some embodiments of the present disclosure;

FIG. 2 is a block diagram of an illustrative system for generating travel diaries, in accordance with some embodiments of the present disclosure;

FIG. 3 is a block diagram of illustrative travel information, in accordance with some embodiments of the present disclosure;

FIGS. 4A and 4B show illustrative driving information, in accordance with some embodiments of the present disclosure;

FIG. 5 is a block diagram of an illustrative process for using charging information to assign charge events, in accordance with some embodiments of the present disclosure;

FIG. 6 shows illustrative charging information to assign charge events, in accordance with some embodiments of the present disclosure;

FIG. 7 is a block diagram of illustrative distribution information, in accordance with some embodiments of the present disclosure;

FIGS. 8A-8C shows illustrative output based on travel diaries, in accordance with some embodiments of the present disclosure;

FIG. 9 is a flowchart of an illustrative process for generating and using travel diaries, in accordance with some embodiments of the present disclosure; and

FIG. 10 is a flowchart of an illustrative process for applying travel diaries to improve failure analysis, in accordance with some embodiments of the present disclosure.

### DESCRIPTION

Vehicle powertrain systems generally must be designed to be durable and reliable over the design life of the vehicle, to minimize wear and warranty claims, for example. Durable designs may require an estimation of the variations and accumulations in loads that may be applied, or may be expected to be applied, to the vehicle's powertrain over the vehicle's life. These loads may be applied by customers in the field. Identification of the most damaging real-world loads that are applied, or expected to be applied, may help in generating durable designs. Currently, this estimation is typically done using expert opinion (e.g., based on field failures) and limited data from new vehicles, with consideration of the most-conservative loading patterns. In doing so, there is potential for either overdesign or under-design for each of the different components, thus adding design, testing, and warranty costs. Further, analysis based only on limited representative historical usage data, user scenarios, and industry experience might not capture the diverse failure modes of different propulsion components. For example, reliance on such representative data may compel designers to add more material mass, size, and capacity to a vehicle or system thereof, thereby also increasing lifecycle emissions, reducing sustainability, and increasing cost.

The present disclosure is directed to methods and systems for combining data from existing customers and travel patterns from drivers in the real-world, along with driving, charging, and weather data from various public databases, to generate a synthetic population of customers and their day-by-day vehicle usage, ranging from purchase to the end of vehicle's design life. In some embodiments, the methods and systems of the present disclosure provide lifetime loads of a customer population, which allows for a more accurate estimation of warranty critical loads. Under some circumstances, this allows setting more realistic durability and reliability targets and reducing costs in design, testing, and warranty claims. For example, the system generates a plurality of travel diaries based on plurality of user profiles, a plurality of travel patterns, drive cycle information of a vehicle, and charging information. The system also generates a load history corresponding to a vehicle component of the vehicle based on the plurality of travel diaries.

In some embodiments, the present disclosure is directed to generating day-by-day time-sequenced loading patterns for a wide variety of customers. For example, a day-by-day approach may be preferred over weekly estimates or other more coarse estimates. To illustrate, the present disclosure may allow generation of a variety of towing usage variations (e.g., once a week in summer but changing frequency in fall), rather than assigning a once-a-week towing load or another coarser approximation.

In some embodiments, the present disclosure is directed to generating more realistic customer profiles. For example, rather than attempting to quantify a single worst-case user who might be a warranty-critical user, or a single representative user which may miss subtleties and cross-couplings, the present discourse is directed to varying the intensity of different use cases using patterns observed in data, to stochastically to generate a population of users and then quantitatively arrive at a design-critical customer. While the single worst-case user may be estimated by combining the most aggressive offroad driving with the most aggressive towing, and the most-frequent track driving, thus essentially ‘stacking the worsts’, this may lead to generation of a likely non-existent design-critical customer. The present disclosure is directed to improving characterization of which customers are design-critical for each system or component.

In some embodiments, the present disclosure is directed to generating travel diaries associated with a user population, allowing identification of which users in the population are design-critical for a respective component or subsystem. In an illustrative example, rather than generate a single design-critical customer for an entire powertrain, the techniques of the present disclosure may discern between a user who is most-damaging to the motor, and one who is most-damaging to the battery, or the half-shafts, as they need not be the same user.

In some embodiments, the methods and systems of the present disclosure may allow a reduction in overdesign of vehicles, reduction in component costs, testing costs, and overall cost of the vehicle. In some embodiments, the present disclosure is directed to reducing blind-spots in design that may arise from lack of real-world usage data, to thus reduce warranty costs. For some components this might also reduce the size and mass, which may result in vehicles that are more sustainable. Such illustrative benefits may help in improving profitability, sustainability, and performance in the marketplace, for example.

In some embodiments, the present disclosure is directed to generating a time sequence of driving, parking, and charging of the vehicle over its life for different customers. For example, different customer archetypes (e.g., aggressive drivers, towing and off-roading user, cold-climate user) may be identified by analyzing existing fleet data and a target customer population for different vehicle variants. Existing public travel pattern data (e.g., national household travel survey by the U.S. Department of Transportation) may be referenced to generate travel diaries (e.g., a trip-by-trip list of travel over the life of the vehicle) for the different customers. Similarly, fleet data, public driving data, any other suitable data, or any combination thereof, may be analyzed to generate a set of representative real-world drive cycles for on-road driving, off-road driving, towing, and track driving, for example. Each trip in the travel diary may be associated with a representative drive cycle. Then, charging sessions (e.g., slow and fast charging sessions) are introduced into these diaries between the travel events using an analysis of reference charging behaviors (e.g., from fleet data). Accordingly, customer usage diaries with a sequence of driving (e.g., different kinds of trips and driving styles), parking (e.g., at different locations and times), and charging (e.g., using different charger types) are generated. These diaries may then be converted to load sequences using vehicle simulation models, to generate vehicle-specific lifetime load patterns for the customers. For example, these loads may form the basis for setting targets of design and testing for durability and reliability. This approach allows the generation of customer usage distributions, quantifying the loads and activity the vehicle undergoes over its life (e.g., warranty life) for the customers. The present disclosure may be applied to powertrain durability and reliability, or any other component or process of the vehicle. For example, the present disclosure may be applied to understand the structural loading in the design of chassis and body structures, (e.g., based on the travel the frequency and count of door opening estimating the load on the door handle and hinge may be estimated). In a further example, the present disclosure may also be implemented to analyze, and modify, how a vehicle thermal system or lighting is used and in what sequence, thereby influencing their design. In some embodiments, the present disclosure is applied to estimate a “remaining life,” which may be used to design controls to increase real-world range or maintain system performance as the vehicle ages. In some embodiments, the present disclosure provides a path to customized vehicle controls to improve a targeted customer experience.

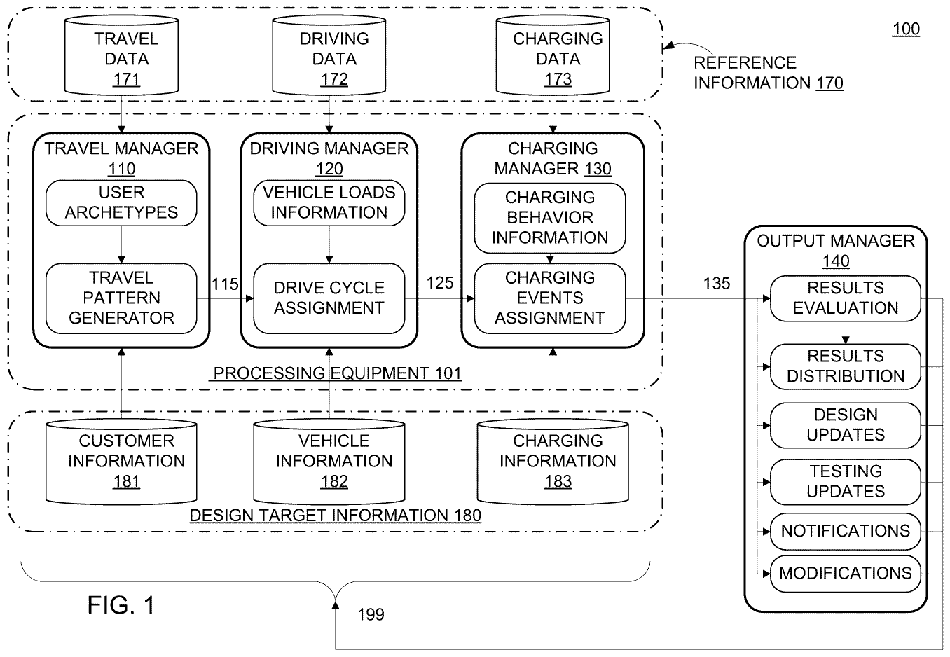

FIG. 1 is a block diagram of illustrative system 100 for managing population information for usage dynamics, in accordance with some embodiments of the present disclosure. As illustrated, system 100 includes travel manager 110, driving manager 120, charging manager 130, reference information 170, design target information 180, and output manager 190. For example, reference information 170 and design target information 180 may be received by travel manager 110, driving manager 120, and charging manager 130 to generate output 135 provided to output manager 140, which may then provide updated information 199 to iterate, repeat, or refine output 135.

In some embodiments, system 100 is implemented in the context of one or more vehicles, electric vehicles, or other suitable systems, or sets, groups, or fleets thereof. For example, reference information 170 may include data corresponding to one or more vehicle types for a plurality of users (e.g., data gathered from the field, data gathered at during design), and system 100 may be used to generate output 135 corresponding to one of the one or more vehicles, another suitable vehicle, or any combination thereof.

Travel manager 110 is configured to generate or retrieve user archetypes, customer information 181, and travel data 171, and generate travel patterns for each user profile of a plurality of user profiles. Each user profile may be generated based on a combination of distributions of user types, and each user profile may correspond to a vehicle instance. The travel pattern may be generated based on a stochastic model (e.g., a Markov chain or any other suitable model), sequencing a plurality of events together, which represent driving activities or otherwise vehicle use activities at a day-to-day resolution. The travel pattern may extend for years, for example, corresponding to an expected vehicle lifetime, target warranty lifetime, or otherwise a predetermined time of interest for vehicle component and system life-cycle analysis. Travel manager 110 outputs a plurality of travel patterns, one for each user that includes a sequence of many vehicle usage events (e.g., trips).

Driving manager 120 is configured to take the travel patterns as input, assign a drive cycle to each vehicle usage event (e.g., each trip), and apply vehicle load information. For example, a travel pattern may include a trip to work and driving manager 120 may apply a drive cycle to the trip that corresponds to a commute drive cycle. The drive cycle may include a mean speed (e.g., based on a distance or road type); a number of stops, starts and turns; a mean acceleration and/or peak acceleration/deceleration; a mean or peak motor speed, gear speed, shaft speed, wheel speed, or any other indication of loading; a predetermine template selected from a plurality of templates that corresponds to the type of trip; any other suitable usage information; or any combination thereof. In some embodiments, driving manager 120 may take as input vehicle information 182, which may include drive cycle information (e.g., templates) for the vehicle type of the analysis. The vehicle type, and corresponding vehicle information 182, may include a production vehicle (e.g., a vehicle available for sale with instances of which on the road), a conceptual vehicle (e.g., at the conceptual or design stage), or any other vehicle for which usage events and drive cycles may be estimated. The output of driving manager 120 may include a drive cycle for each trip for each user profile (e.g., a total number equal to the sum of all trips for all user profiles).

Charging manager 130 is configured to take as input the drive cycles, charging information 183, and charging data 173, along with determined charging behavior information to assign charging events to each travel diary. For example, the input to charging manager 130 may be a sequence of events for each user profile that may include driving events (e.g., trips). Charging manager 130 may apply a discharging/charging model (e.g., based on information from charging information 183, charging data 173, or both) to determine a state of charge for the vehicle before each event, during each event, or after each event. Based on a charging behavior model, charging manager 130 may determine when a particular user profile will charge, and what type of charger will be used. For example, for each user profile, a charging behavior may be determined based on statistical data and real-world charging behavior, along with a projected charging behavior for each user archetype. Charging manager 130 may analyze the drive cycles sequentially to determine a charging event, insert a charging event into the travel diary, determine a new state of charge, and repeat the process while continuing through the rest of the sequence. For example, for each user profile (e.g., for each travel diary), charging manager 130 may insert a plurality of charging events (e.g., at a suitable location among the sequence of events), add a state of charge metric to each driving event in the travel diary (e.g., a charge metric), insert a cumulative count of charging events/cycles, or a combination thereof. The output of charging manager 130 may be a plurality of travel diaries, one for each user profile, that each include a plurality of driving and charging events arranged in a sequence spanning a predetermine time period (e.g., a target vehicle life).

Output manager 140 is configured to evaluate the results based on predetermined criteria (e.g., using loading models, damage models, or any other suitable models), compile distributions based on metrics determined for each travel diary, perform updates or modifications to design parameters, testing parameters, warranty information (e.g., warranty notifications), store results or data for use in future modeling (e.g., stored in reference information 170, design target information 180, or both), any other suitable actions, or any combination thereof. For example, output manager 140 may be configured to perform or manage iterations, by determining results and perturbing one or more of travel manager 110, driving manager 120, or charging manager 130 based on updates to the travel patterns, drive cycles, or charging events. To illustrate, output manager 140 may analyze results and then modify a component design, which may require an update to vehicle load information to generate the drive cycles and charging behavior (e.g., the travel pattern may remain, in some circumstances).

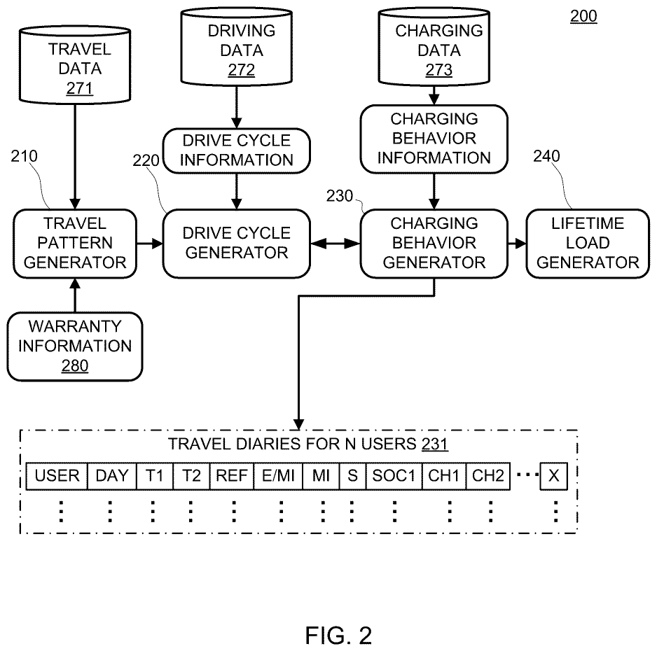

FIG. 2 is a block diagram of illustrative system 200 for generating travel diaries, in accordance with some embodiments of the present disclosure. In some embodiments, system 200 is an example of system 100 of FIG. 1. As illustrated, system 200 includes travel pattern generator 210, drive cycle generator 220, charging behavior generator 230, and lifetime load generator 240. For example, system 200 may take as input one or more sets of data, parameters, algorithms, any other suitable information, or any combination thereof, and then output travel diaries associated with one or more simulated users for a predetermined warranty life of a vehicle. The travel diaries may be used by a damage estimator to determine a distribution of expected usage, damage, wear rates or amounts, number of cycles, health metrics, or any other suitable metric corresponding to one or more components, subsystems, or assemblies of the vehicle. For example, a total of N travel diaries may be generated for a predetermined warranty life of Y years or M miles of usage for a particular vehicle make/model/configuration. The N travel diaries may be inputted to models to determine usage estimates of systems. The distribution of usage estimates may then be analyzed to determine aggregate cumulative usage distributions. Distributions of energy throughput, mileage, number of charges, trip mean speed, SOC, any other suitable value, or any distribution thereof.

In some embodiments, travel pattern generator 210 determines user archetypes based on travel data 271. Travel pattern generator 210 generates a travel diary for each of a set of simulated users, ranging from an initial time (e.g., purchase of the vehicle) until an ending time (e.g., a predetermined number of days, years, or miles). For each user, travel pattern generator 210 generates a sequence of trips, wherein there may be multiple trips per day. In some embodiments, a set of rules is applied for each day in order to determine the trips for that day. In some embodiments, travel pattern generator 210 may stochastically chain travel days using one or more chaining rules. Travel pattern generator 210 may estimate a frequency of various drive modes (e.g., towing frequency) and distribution parameters specifying intensity of usage (e.g., towed weight), extract representative travel days (e.g., sequence of driving activities on weekdays, weekends, summer, and winter), generate stochastic travel history using rule-based Markov chaining, or a combination thereof.

In some embodiments, drive cycle generator 220 determines a drive cycle for each trip in each users' travel diary. A drive cycle may include, for example, a time series of speed, grade, towing, any other variable, or any combination thereof for each trip. Based on drive cycle information, drive cycle generator 220 may determine a mean speed, variation in acceleration, variation in grade, vehicle mass, variation in lateral acceleration, trip length, any other suitable metric in order to determine torque, power, current, temperature, or other quantity. Drive cycle generator 220 may employ a model of the drive system to estimate torque, power, current, temperature, or the other quantity, for each trip on each day for each user. Drive cycle generator 220 may identify principal drive cycle statistics that influence degradation modes (e.g., energy throughput may be most influenced by mean speed and standard deviation of acceleration of driving), cluster drive cycles based on these principal statistics and select representative drive cycles (e.g., low-speed, high-acceleration drive cycles, high-grade and acceleration drive cycle), and assign drive cycles to the travel history generated by travel pattern generator 210 to generate a driving/idle history. The driving history may also include parking history.

In some embodiments, charging behavior generator 230 determines charging behavior for each users' driving and parking patterns, for each trip of each day. Charging behavior generator 230 may add charging events to the users' travel diaries, add charging information for each trip (e.g., after each trip), or otherwise append the output of drive cycle generator 220 with charging information. Charging behavior generator 230 may extract representative charging parameters from fleet charging behavior (e.g., probability of plugging in at different SOCs), calculate a change in SOC following driving history, assign a charging session when the vehicle is suitably parked.

In an illustrative example, the system may generate travel diaries 231 that include, after processing by charging behavior generator 230, a list of events for each user. For example, for each user of N total users, the respective travel diary of travel diaries 231 may include a list of driving events and charging events. For example, as illustrated, travel diaries 231 may include a number of rows equivalent to a sum, over all user profiles, of total trip events for each user profile.

In some embodiments, lifetime load generator 240 determines damage distributions for a component or system of the vehicle. For example, because the travel diary includes detailed information, lifetime load generator 240 can determine the number of certain events, the intensity of certain events, cumulative loadings, or other values in order to estimate a wear, damage, or useful lifetime. In a further example, lifetime load generator 240 may generate a histogram corresponding to a distribution of results (e.g., energy consumption in W*h/mile, % users with cell weld damage, % users with power module damage, user mileage during a time period such as 10 years, % trips with mean speed). In a further example, lifetime load generator 240 may determine a distribution of percentages of types of driving (e.g., neighborhood, city road, city hill climb, country road, highway road, hill climb, Davis Dam grade, high speed track, or any other suitable drive cycle).

In an illustrative example, the system may aim to replicate vehicle usage of an actual customer population and contains the correct proportion of different archetypes of users that form the target customer population for the vehicle (e.g., the correct proportion of users in regions with different ambient temperature variations, users that undertake off-road driving, and users that tow). The system assigns each user in the synthetic population a sequence of travel, driving, parking, and charging events, and each such event is quantified (e.g., the type of driving and drive cycle, and the type of charging and the amount of charging). The system may use data from telemetry and surveys, and use a cadence of three models: travel, driving, and charging models.

In a further example, the system may take as input a time series data of vehicle speed, grade, drive mode, ambient temperature, battery SOC, and type of charging or charging power. The system may also take as input additional data such as location, purpose of travel, energy-use, o for example. In some circumstances, time series data may be available in vehicle telemetry data, or may be combined from different sources (e.g., need not rely on getting all the data from the same source). In some embodiments, the system merges time series and event-based data on driving, travel, and charging from different datasets and different users to estimate usage behavior.

In a further example, the system may use public datasets corresponding to other vehicles to model usage behavior (e.g., travel survey data from National Household Travel Survey 2017 (NHTS), drive cycle data from National Renewable Energy Laboratory (NREL)). In addition, the system may use telemetry data. In some embodiments, the system need not use identifiable information of individual customers and vehicles from telemetry data, but rather aggregated or anonymized data. In an illustrative example, NHTS data may include a description of trips undertaken in one day by over 130,000 different households across the Unites States, on different days in a year. This data includes day, date, length, duration, purpose, origin, destination type, departure time of the trips, odometer mileage, and the type of vehicle driven. Further, NREL drive cycle data may include about 120,000 GPS-based vehicle speed time series collected across the US from different vehicles. The present disclosure may use such data, any other suitable data, or any combination thereof.

### Travel Patterns

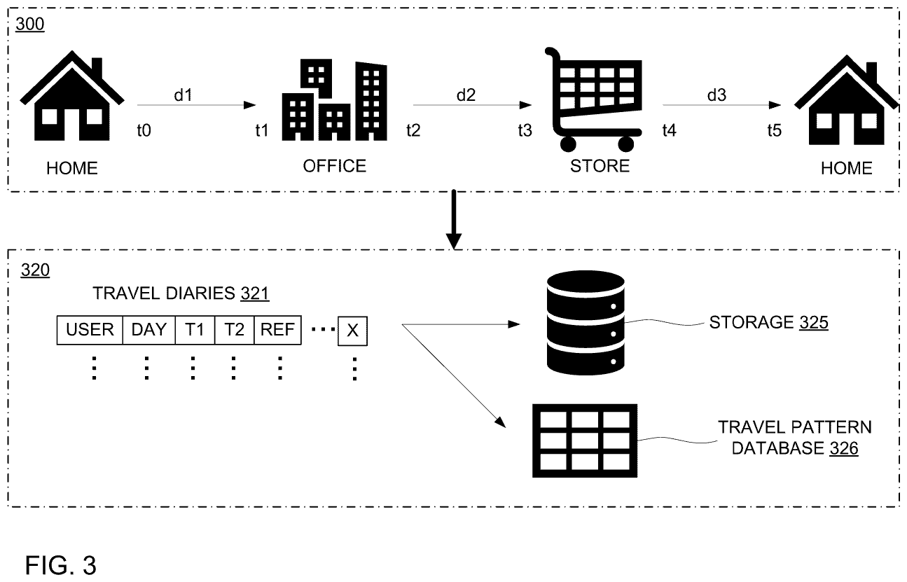

FIG. 3 is a block diagram of illustrative travel information 300, in accordance with some embodiments of the present disclosure. Travel information 300 may include information on the sequence of trips on a day from the household (e.g., from the National Highway Traffic Safety Administration (NHTSA)). Each trip may extend, for example, from an origin to a destination, and optionally back to the origin (e.g., the return trip may alternatively be another separate trip event). For example, an illustrative trip may include an identification of a location (e.g., home, office, work, store, park, identified location on a map), departure and arrival times and dates (e.g., times t0, t1, t2, t3, t4, t5 of FIG. 3), a length of each leg of the trip (e.g., distances d1, d2, and d3 of FIG. 3), any other suitable information, or any combination thereof. Travel information may be stored in any suitable manner on any suitable device. For example, travel information 300 may be stored in cloud-based storage, a hard drive, a server, or any other suitable memory, and may be accessed as a file, collection of files, collection of values (e.g., from a webpage), packet, or any other suitable form. Travel information 300 may be collected from a one or more sources via downloading, query and response, timed data push, or any other suitable method, at any suitable interval.

In some embodiments, the system divides the target population into a plurality of user archetypes (e.g., users that drive off-road, tow, do neither, or do both). For example, the system may use a target customer study, telemetry data on existing vehicle fleets, or any other suitable information source. In some embodiments, the system generates a day-by-day travel diary of the synthetic users from the day of vehicle purchase (e.g., Day 1) to an end of the design life of the vehicle (e.g., Day n), which may span several years. In some embodiments, the system may factor in any expected change of ownership, and adjust the travel pattern accordingly (e.g., update a user profile based on another archetype for subsequent events). In some embodiments, the travel diary is generated by stochastically chaining travel days based on the travel data using one or more chaining rules. To illustrate, the travel events for each day may depend on a previous day's events or properties, a previous event, a time of year, a time of day, a day of the week, any other suitable information, or any combination thereof.

In an illustrative example, reference data (e.g., NHTSA data) may include single-day travel data from households in the US over a time period (e.g., one year). In some embodiments, the system applies a combination of random sampling and chaining, constrained by a set of chaining rules. Accordingly, each user's travel diary is generated. The chaining rules may include, for example:
1. Travel days assigned to a workweek or a weekend must be workweek or weekend travel days from the dataset, respectively. This may account for the differences in weekend and workweek travel patterns;
2. Travel days in a month are selected from travel days observed in the same month from the dataset. This may account for the influence of seasons on travel patterns; and
3. Every subsequent travel day assigned in the diary must start at the same location (e.g., home, work, or other suitable locations) where the previous travel day concluded (e.g., the last trip event of the previous day). Additionally, if a vehicle trip indicates the vehicle was driving at midnight, the next day may start with a driving state. The system may generate output 320, which may include travel diaries 321 corresponding to a set of synthetic users, and containing time-sequenced patterns of travel and parking (e.g., user identification USER, time/date DAY, start time T1, end time T2, type of travel REF, and any other suitable information X). Travel diaries 321 may be stored on any suitable device (e.g., storage device 325), in any suitable format (e.g., database 326).

### Drive Cycles

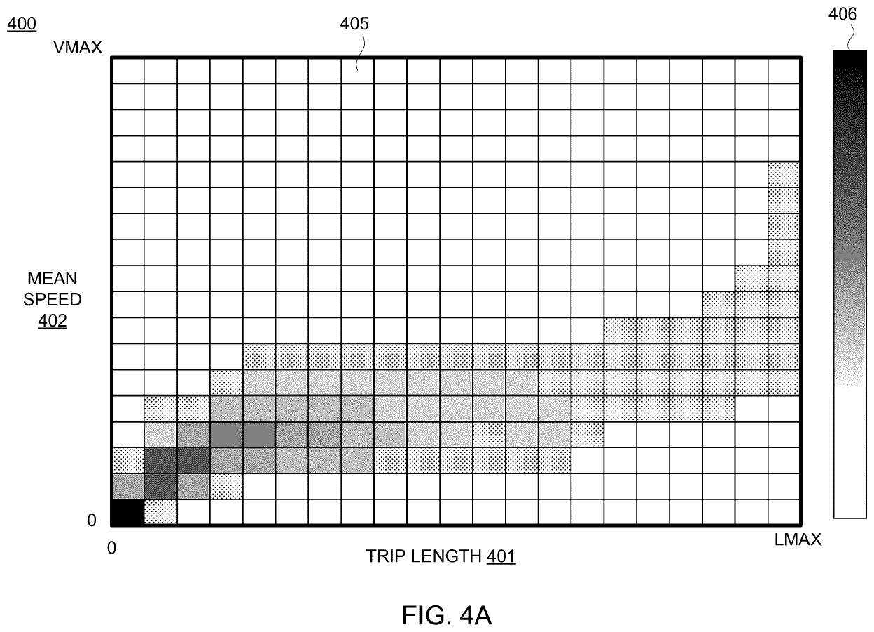

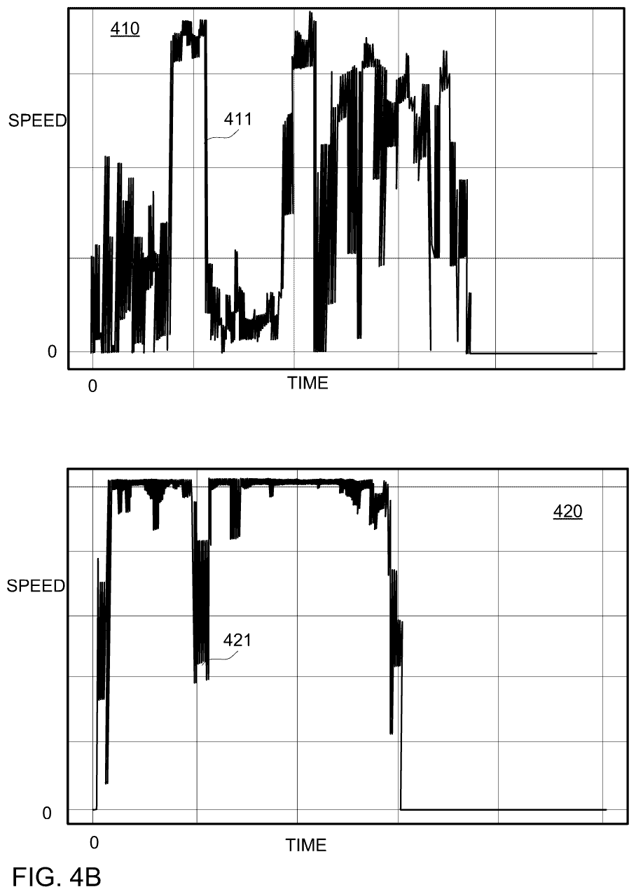

FIG. 4A is a block diagram of illustrative driving information 400, in accordance with some embodiments of the present disclosure. As illustrated, driving information 400 includes a distribution of drive cycles (e.g., approximately 120,000 from NREL) distributed into mean-speed (e.g., ordinate 402 as illustrated) and trip-length (e.g., abscissa 401 as illustrated) bins with the percentage of drive cycles in each bin listed on the bin. It can be observed, for example, that there is a positive correlation between mean speed and trip distance (e.g., small trips have lower mean speeds and long trips have greater mean speeds). Additionally, the density of drive cycles is higher at lower speeds and trip lengths indicating that most real-world driving happens in short trips less than 10 miles in length and below 40 mph average speeds (e.g., see panels 410 and 420 of FIG. 4B). Each entry (e.g., each discretization 405, as illustrated), may correspond to a number (e.g., the percentage of drive cycles of the distribution), with the shading (e.g., shading scale 406) corresponding to percentage of drive cycles. For example, the two-dimensional distribution across abscissa 401 and ordinate 402 may be normalized to one for all trips (e.g., the distribution may be numerically integrated across both dimensions to normalize). In a further example, a set of one-dimensional distributions across ordinate 402 for a given width in abscissa 401 may each be normalized to one for all speeds (e.g., the distribution may be numerically integrated across ordinate 402 to normalize). In a further example, a set of one-dimensional distributions across abscissa 401 for a given width in ordinate 402 may each be normalized to one for all trips (e.g., the distribution may be numerically integrated across abscissa 401 to normalize). The ranges of abscissa 401 and ordinate 402 may be selected as any suitable values, and may correspond to a range of values in available data. As illustrated, the scale of abscissa 401 and ordinate 402 need not be linear or regular, and any suitable discretization may be applied to generate the distribution.

In some embodiments, the system uses a driving model to assign drive cycles (e.g., time series of speed and grade) to each trip in the users' diaries. In some embodiments, the system analyzes a drive cycle database (e.g., reference drive information) to obtain a reduced set of drive cycles that cover the range of variations in real-world driving (e.g., representative drive cycles). The drive cycles in the drive cycle database may be classified by (e.g., binned or otherwise arranged, sorted, or grouped by) mean speed, trip distance, net change in grade, standard deviation or otherwise variation of grade, standard deviation or otherwise variation of acceleration (e.g., representative of driver aggressiveness), any other suitable information, or any combination thereof. For example, for each bin, a single drive cycle is chosen that is closest to all the other drive cycles in the bin and designated as the representative drive cycle of that bin. Any suitable measure of closeness between time series can be utilized to identify the representative drive cycle of the bin (e.g., a Jensen-Shannon divergence). In some embodiments, the system may classify trips based on mean speed (e.g., city if less than 35 mph, otherwise highway), adjust drive cycles (e.g., truncate for length) or select drive cycles of a suitable length, use an energy per mile estimate to estimate battery state of energy, or any other suitable criteria.

Shown in panels 410 and 420 of FIG. 4B are two representative drive cycles for different drive cycle behavior (e.g., bins of the discretization of FIG. 4A, for a respective mean trip speed and mean trip length). In panels 410 and 420, the divisions of the abscissa are increments of 1000 seconds, and the divisions of the ordinate are increments of 20 mph. Both bins represent long highway trips but very different average mean speeds, thereby capturing significant real-world variations in driving that cannot be represented by a single highway cycle. For example, drive cycle 421 in panel 420 may be more likely to damage a propulsion system thermally due to its near-constant high-speed driving, while drive cycle 411 in panel 410 may be more likely to impact a gearbox and inverter with sharp accelerations from low to high speeds resulting in high RMS currents and instantaneous torques.

In some embodiments, the system assigns a drive cycle to each trip in the travel diaries based on the set of representative drive cycles identified. The system may assign the drive cycle based on mean speed, distance, trip purpose, any information available in the reference data, additional modeling assumptions, any other suitable information, or any combination thereof. For example, the system may use telemetry data to determine grade and drive aggressiveness as additional criteria to assign drive cycle to trips. When using driver aggressiveness as a criterion, for example, each user may be classified as an aggressive, moderate, or a mild driver, and only the drive cycles with respective high, medium, or low standard deviation of acceleration be assigned to that user. In this way, a user's personal characteristics can affect the selection of the drive cycle for a trip in the travel diary associated with that user.

In some embodiments, the system uses trip mean speed and trip length as indicators of energy use during driving. The system may output a plurality of travel diaries having time-sequenced patterns of travel and parked events, where the driving in each of the travel events is quantified using an appropriate drive cycle. For example, the travel diary generated based on travel patterns is appended with drive cycle information to result in an updated travel diary. In a further example, referencing tabulated data, for each row of a travel diary (e.g., corresponding to one trip event for a user), the system populates columns with drive cycle information (e.g., drive cycle identifier, energy per mile, total miles, mean speed, state of charge before and after, any other suitable information).

### Charging Behavior

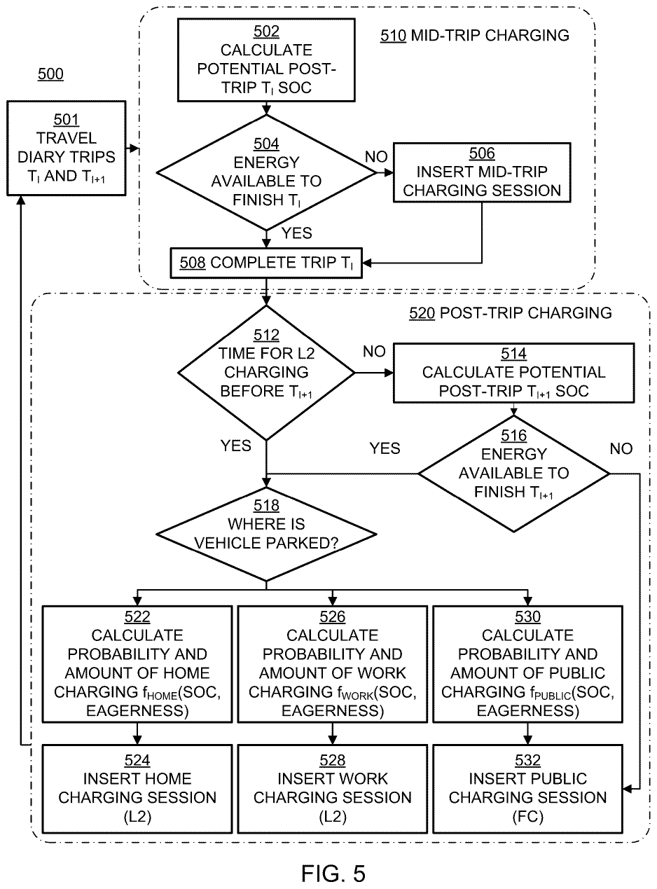

FIG. 5 is a block diagram of illustrative process 500 for using charging information to assign charge events, in accordance with some embodiments of the present disclosure. The charging information may be used in conjunction with travel diaries 231, for example, to determine charging events over the vehicle life. For example, a travel diary generated at step 501 may include a sequence of trips, and the drive cycles used on those trips. The system may then use a suitable vehicle model so that the drive cycles can be converted to time series of torque use, power use, temperature change, energy use, any other suitable parameter, or any combination thereof. For example, these quantities represent the load on the vehicle and indicate a cause of wear to the components of the vehicle. This information may be appended/updated with charging sequence information estimated for the vehicle. This information is important to charge events themselves, and to ensure the vehicle is able to complete the trips in the travel diary. This information also allows the system to account for changes in electrical and thermal loads of the vehicle during and after charging.

Process 510 is directed to mid-trip charging analysis, to determine whether each trip may be completed using the SOC at the beginning of the trip, and characteristics of the trip. For each trip in each travel diary, the system. In some embodiments, the system uses a charging model that probabilistically assigns charging events between trips (e.g., in each travel diary) based on the location where the vehicle is parked, parked time available for charging, SOC of vehicle due to the trips taken prior to the parking event, the energy needed to complete the next trip (e.g., at step 502), any other suitable information, or any combination thereof. For example, if the system determines at step 504 that a single trip requires energy greater than the energy available in a full charge (e.g., determines “NO” to whether there is energy available to finish the trip), the system may insert a fast charge session undertaken mid-trip into the travel diary (e.g., at step 506). In a further example, the system may assume that trip duration for such trips reported in the travel already includes breaks that can be used for fast charging. In some circumstances, the system may assume that the change in trip duration beyond utilization of these breaks, if any, is to be small as to not affect the departure time for the next trip in the travel diary. In some embodiments, the system implements process 510 to determine, for each trip of each travel diary, whether a charge needs to be completed during the trip either to complete the trip, a portion or leg of the trip, or otherwise maintain a minimum SOC of the vehicle. In some embodiments, during process 510, the system injects charging events into the travel diary at step 506 (e.g., either between trips, within a trip, or between sections of a partitioned trip that have been segmented into one or more sections based on step 506).

Process 520 is directed to post-trip charging analysis, to determine whether a charging event need be inserted into the travel diary. Step 512 includes determining whether there is sufficient time between events (e.g., an end of a first event and a beginning of a next event) to allow for L2 charging (e.g., AC charging, or lower-current charging). For example, L2 charging may correspond to a residential AC charger, or otherwise a Level 2 charger. If there is time to achieve L2 charging, the system then proceeds to step 518 to determine where the vehicle is parked (e.g., the location of the end of the previous trip). Based on the location, the system determines a probability of several types of charging at one or more of steps 522, 526, and 530, and selects the most probable charging modality, for example. Based on the most probable modality, the system inserts the corresponding type of charging event into the travel diary at one or more of steps 524, 528, and 532. If there is insufficient time for L2 charging between events, the system proceeds to step 514 to determine a potential post-trip SOC based on the next event. The system then proceeds to step 516 to determine if the current SOC is sufficient to achieve the next event. If it is sufficient, the system proceeds to step 518. If it is insufficient, the system proceeds to step 532 and inserts a public charging session (e.g., to occur at a public charger).

In an illustrative example, referencing FIG. 5, the system may use a charging model that parametrizes charging behavior using probabilities of plugging into a charger at home, work, and public as a function of SOC of the vehicle and a user eagerness factor: f_home (SOC, eagerness), f_work (SOC, eagerness), f_public (SOC, eagerness). For example, the user eagerness factor is a real number between 0 and 1 and may allow the system to model differences among users on their eagerness to charge their vehicle. To illustrate, a most risk-averse user who charges when the battery SOC drops below the upper threshold has a user eagerness factor of 1. The most risk-taking user who charges only when the battery SOC reaches its lower threshold or if charging is needed to complete the next trip may have a user eagerness factor of 0. In some embodiments, each user of the set may be assigned a user eagerness factor randomly sampled from a uniform distribution. The probability of unplugging a fast charger can be modeled similarly (e.g., the user need not wait for the SOC to reach 100%). In the case of home or work charging, the vehicle may be assumed to charge either to full charge, or charged until the vehicle is left parked, prior to the start of the next trip.

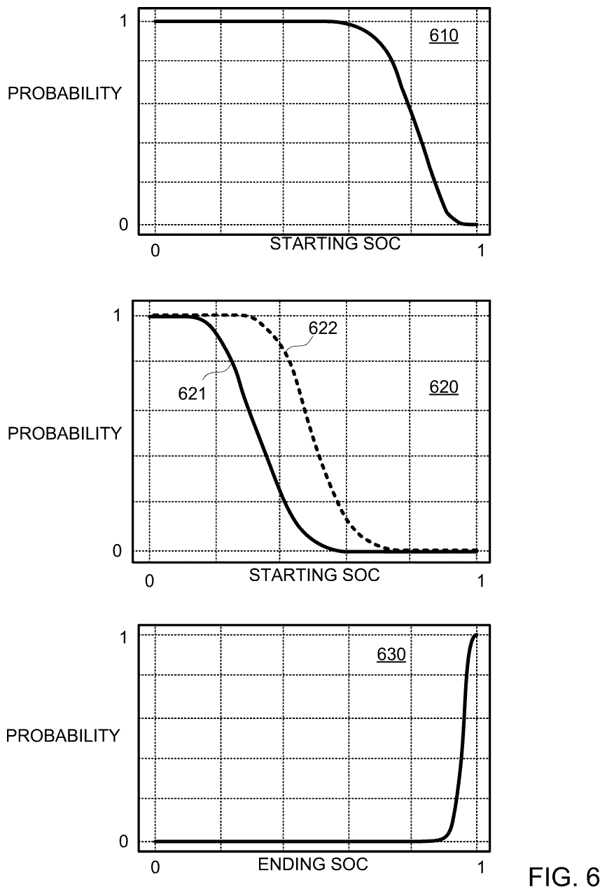

FIG. 6 shows illustrative charging information to assign charge events, in accordance with some embodiments of the present disclosure. As illustrated in FIG. 6, the system may apply one or more charging modes (e.g., Level 2 or L2 charging, or fast charging (FC)). FIG. 6 shows illustrative examples of charging probabilities that the system may use. Panel 610 shows the probability of a user plugging into a L2 charger as a function of initial SOC (e.g., the probability is 100% for SOCs below about 0.6). Panel 620 shows the probability of plugging into a DC fast charger as a function of initial SOC (e.g., trace 621 is for a risk-taking user tolerating lesser SOC, and trace 622 is for a risk-averse user requiring greater SOC). In some embodiments, a plurality of distributions, or a two-dimensional distribution may be used, where a risk aversion metric of each user may be used to determine the probability of charging (e.g., the distribution is across SOC and risk aversion metric). Panel 630 shows an illustrative probability of a user unplugging a DC fast charger as a function of ending SOC (e.g., a very low or zero probability when the SOC is below about 0.9). In some embodiments, the system may determine criteria for when and how a user charges the vehicle. For example, the system may apply rules such as: if SOE>30% and at home, then charge 70% of the time; if SOE<=30% and at home or work then will charge; if a long trip is imminent and SOE is not sufficient (DOD>80%) then fast charge; and if at work for more than a time period (e.g., 30 minutes) then charge using an L2 charger. Further, the system may apply rules for users that may only use fast charger such as: if SOE<=40% then fast charge; and if a long trip is planed that will reduce SOE by 20% then stop and fast charge. The system may use any suitable rules and criteria in assigning charging events to each trip and drive cycle in the travel diary.

Although the illustrative probability distributions depicted in FIG. 6 are empirically derived from user data, the system may use a charging model that is a parametric model. For example, the system may take into account personal preferences in charging behavior that can be accommodated through the user eagerness parameter and charging thresholds. The system may estimate the parameters or probabilities based on the data to allow the methodology to be adapted on any available and suitable charging dataset. For example, the synthetic population generated by this approach accounts for variations in charging behavior and their influence on the damage over life. After inserting the charging information into the travel diaries, the system may output the travel diaries for distribution analysis, load history analysis, or other actions.

### Travel Diaries and Distributions

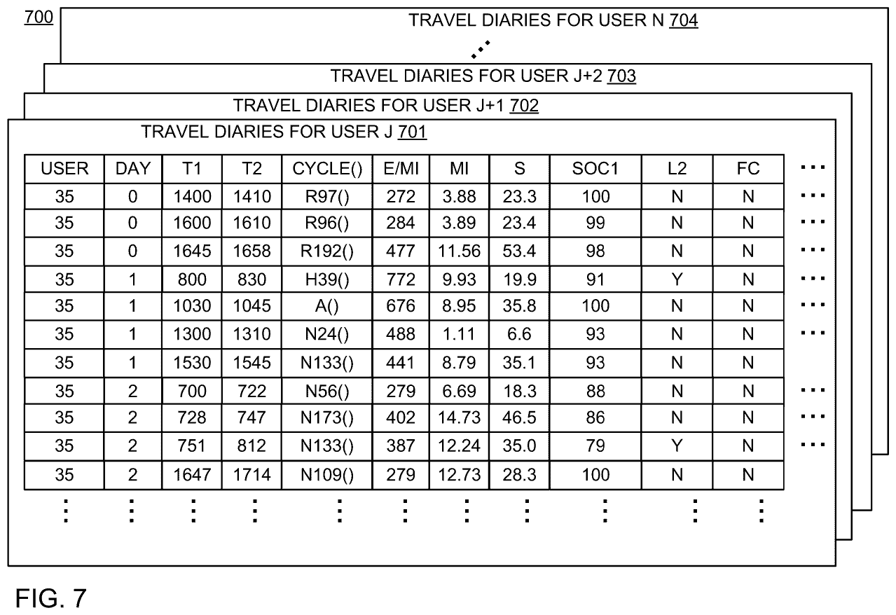

FIG. 7 is a block diagram of illustrative distribution information 700, in accordance with some embodiments of the present disclosure. Distribution information 700 may include the travel diaries of the plurality of simulated users, including travel diaries 701-704 (e.g., trip events with corresponding drive cycles and charging events). For example, the system may output updated travel diaries of synthetic users containing time-ordered sequences of travel, driving, parking, and charging events. In some embodiments, the system may couple the output with an appropriate vehicle model to provide a time series of torque, power, current, or any other load over the life of the vehicle, for example. A truncated (first three days only) example of travel diary 701 is illustrated in FIG. 7, where each trip, its start and end time, drive cycles identifier (e.g., NREL, HWY, A, including a number of repetitions), energy consumption (Watt-hour/mile), trip length (e.g., in miles or km), mean speed (e.g., in mph or km/hr), start SOC (e.g., in percent), and whether there is a charge event after the trip and the type of charging are shown. In some embodiments, the system may generate load histories, and damage distributions, for any component or system of interest. IT will be understood that a length of a travel diary may be any suitable time (e.g., an include any suitable number of events), such as 5 yrs., 10 yrs., an estimated or target vehicle life, a target warranty life, or any other suitable duration. The distribution of damage can be used, for example, to identify the user (or set of users) that are most damaging to the component (e.g., the warranty-critical durability loads for the component). Accordingly, for each travel diary, the system may apply a load model, a damage model, or both to each event, thus determining a cumulative estimate of loading or damage (e.g., after each event, at a frequency such as annually, or at the end of the vehicle life or other diary duration).

### Load Histories and Analysis

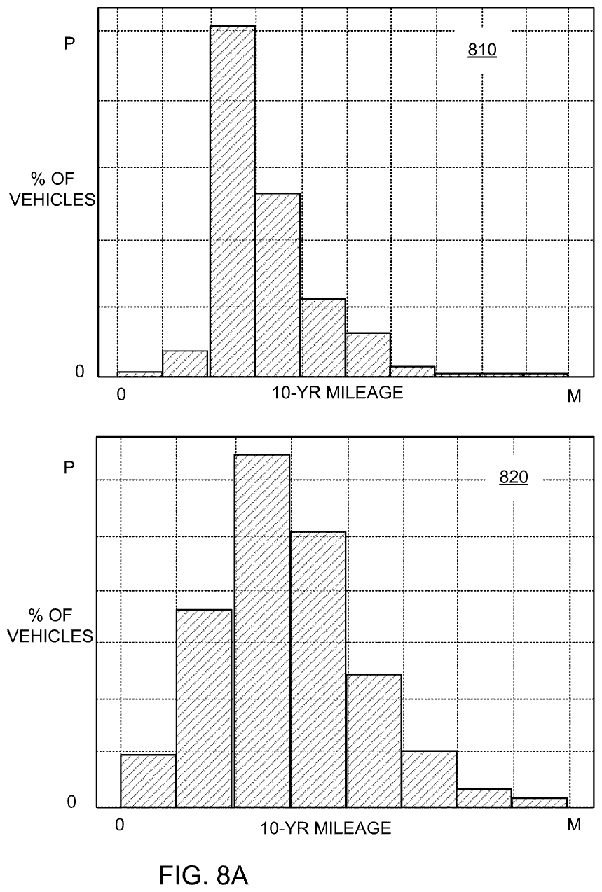

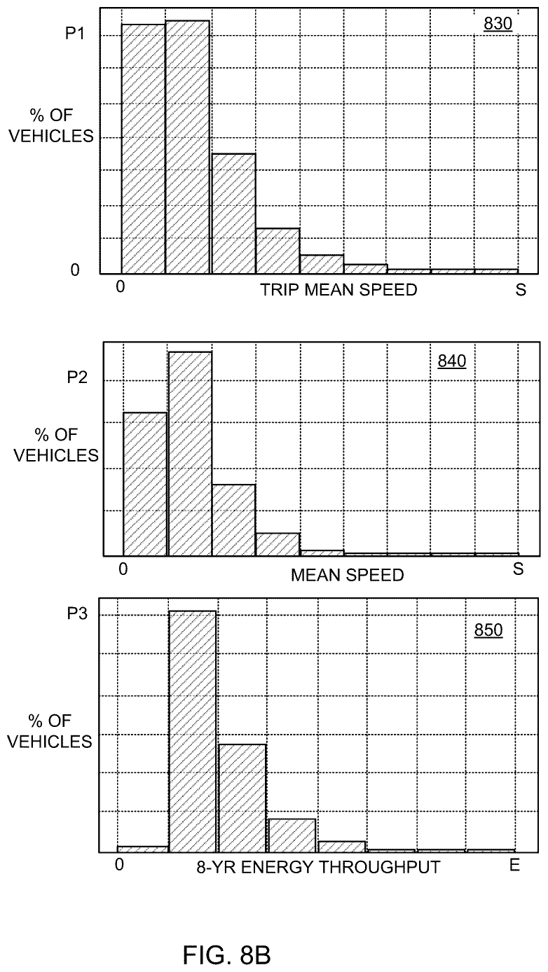

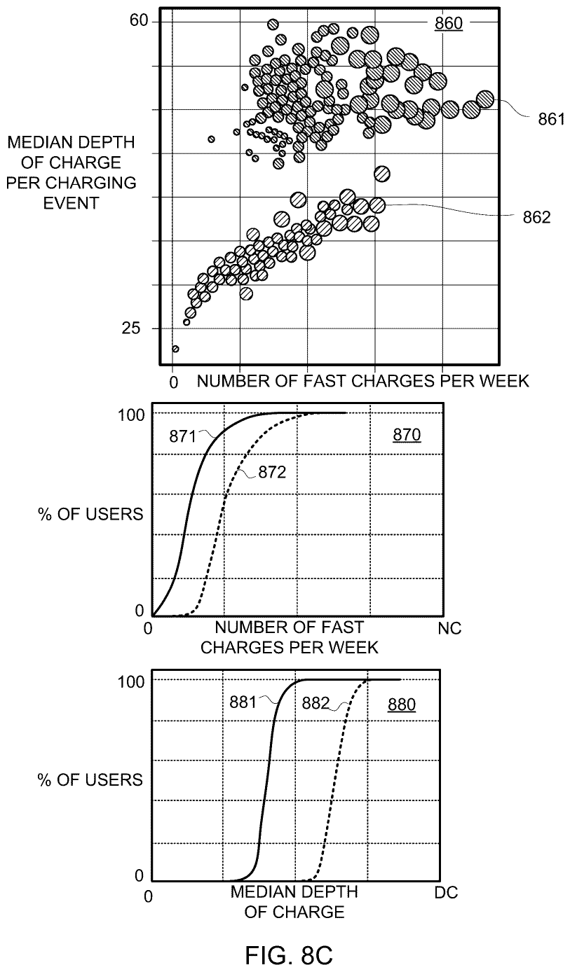

FIGS. 8A-8C shows illustrative output based on travel diaries, in accordance with some embodiments of the present disclosure. In an illustrative example, the system may generate travel diaries and then determine battery cell degradation based on the travel diaries. FIGS. 8A-8C shows illustrative results. In some circumstances, battery cells in EV battery packs may undergo degradation due to use (loads) and life (calendar aging), which reduce a usable battery energy over time. For customers to have a reasonable range at the end of the warranty period or design life, cells may be designed such that the battery retains a certain percentage of its usable battery energy at the end of life. Battery degradation is a complex electrochemical process and is generally affected by the overall energy-use cycles during driving and charging, the power draw amplitudes, and the number of fast charging events (e.g., that are both power and thermally stressful). The system may be configured to predict the distribution of the overall energy consumption, the energy consumption per mile (indicator of power draw), the number of fast charging sessions, and the amount of charge in those fast-charging sessions. As discussed herein, any suitable reference data may be used (e.g., a NHTS dataset for travel data and NREL drive cycles for driving characterization). For example, for validation, the system may use a limited number of statistics obtained from telemetry data from vehicles of interest.

To illustrate, for each travel diary of N diaries, the system may determine the total mileage at the Y-year mark (e.g., a warranty life, or other suitable predetermined duration). The distribution of N data points of mileage may be used to generate a distribution, similar to that illustrated in panel 810. In an illustrative example, using the travel model and NHTS data, the system may generate a set of 1000 synthetic users. Panel 810 of FIG. 8A shows an illustrative 10-yr cumulative mileage distribution of these users (e.g., percentage of users plotted as a function of total mileage M), as compared with panel 820 illustrating real-world 10-yr odometer data from approximately 10,000 vehicles in the NHTS data. The divisions in the abscissa in panels 810 and 820 are increments of 30,000 miles. The divisions in the ordinate in panel 810 are increments of 10%, and the divisions in the ordinate in panel 820 are increments of 5%. As illustrated, the stochastically generated users show a similar 10-yr mileage distribution particularly on and above the mean. The error is less than 5% for the mean mileage, and less than 1% for the 95th percentile mileage. This indicates the ability of the travel model to generate travel diaries with real-world-like lifetime usage. The synthetic data is more conservative for the low-mileage users, but those users are less likely to have high cumulative damage based on very low overall usage.

FIG. 8B illustrates distributions of percentage of vehicles and trip mean speed over Y years in panels 830 and 840. The divisions in the abscissa in panels 830 and 840 are increments of 15 mph. The divisions in the ordinate in panel 830 are increments of 5%, and the divisions in the ordinate in panel 840 are increments of 10%. In some embodiments, the system assigns drive cycles to the travel diaries of N synthetic users. The over-life mean speed distribution for all synthetic users is shown in panel 830 of FIG. 8B (e.g., 250 users were used for panels 830), compared with the distribution of average trip speeds observed in data from actual users in panel 840 of FIG. 8B. As illustrated in panels 830 and 840 (e.g., showing percentage of vehicles/users plotted as a function of mean trip speed S), the distribution developed from the synthetic users may be similar to that from the real-world data (e.g., exhibiting a higher 95th percentile trip average speed). This may imply that, in some circumstances, drive cycle assignments at least with respect to trip mean speeds and trip distances is representative of real-world usage. In some embodiments, the system may use other metrics such as acceleration when using OEM fleet data over the NHTS data that does not contain acceleration information. For the purpose of the current disclosure, FIGS. 8A and 8B demonstrate a synthetic population approach in determining accurate travel and driving time histories over life. Mean speed and trip lengths may also be also good indicators of energy use in some circumstances, allowing the system to generate an accurate distribution of these parameters through the travel and driving models to estimate cell degradation loads (e.g., or any other suitable loads) with confidence.

Based on the travel diaries, the distribution of total energy use (i.e., energy throughput) can be generated using an appropriate vehicle model. Shown in panel 850 of FIG. 8B is a distribution of the estimated lifetime energy consumption for the synthetic population, i.e., energy added and consumed from the battery pack for the vehicle (e.g., plotted as percentage of vehicles plotted as a function of total energy throughput E in MWhr). The divisions in the abscissa in panel 850 are increments of 20 MWhr, and the divisions in the ordinate are increments of 10%. For example, the system may, for each travel diary, determine the cumulative energy added and consumed for the totality of events to determine a total value. The set of total values (e.g., N values for N synthetic users) may be used to generate a distribution to perform statistical analysis (e.g., the 95% value, or any other suitable value).

Panel 860 of FIG. 8C shows an estimated distribution of the number of fast charging events per week and the depth of fast charge in these events for two types of customers: (a) those that are least likely to use fast charging due to access to both L2 charging and fast charging (e.g., distribution 862), and (b) those that have no regular access to L2 charging and use only fast charging (e.g., distribution 861). The latter type of customer who strictly does only fast charging, although unrealistic, represents the most-damaging charging behavior and serves as an upper bound for cell damage estimates. The divisions along the abscissa increment by one (e.g., corresponding to 0, 1, 2, 3, or 4 fast chargers per week). The divisions along the ordinate increment by 5% in depth of charge per charging event (e.g., in SOC). The size of the marker for each data point of distributions 861 and 862 corresponds to 8-yr mileage, ranging from 30 k to 180 k miles).

In panels 870 and 880 of FIG. 8C, distributions 871 and 881 corresponds to users having access to both L2 and DCFC chargers, and distributions 872 and 882 corresponds to users having access only to a DCFC charger. Panel 870 illustrates the distribution of users over NC the number of fast charges per week (e.g., each tic along the abscissa corresponds to 2 charges/week). Panel 880 illustrates the distribution of users over DC the median depth of charge (e.g., each tic along the abscissa corresponds to 20% in SOC). Panels 870 and 880 of FIG. 8C illustrate that users who have access to both types of chargers (e.g., L2 and DCFC) may tend to charge less per charge session and typically have a fewer number of fast charging events per week, for example. In some such cases, users with high overall mileage may do more counts of fast charging and higher amounts of it. In contrast, users who only rely on fast chargers (e.g., distribution 882) may have a uniform distribution of depth of charge around 55% SOC and among those, the users who have more mileage charge more often. Most importantly, the illustrative distribution suggests that durability critical users are likely to have about 2 or 3 and certainly less than 4 fast charge sessions per week.

In some embodiments, these results offer a robust way to design for durability and reliability and a data-driven approach to design testing targets for durability and reliability at all stages of vehicle design and development. The distributions illustrated in FIG. 8C may be generated based on the travel diaries of N users, and the load histories of the battery systems may be analyzed to determine design, testing, servicing, or warranty thresholds.

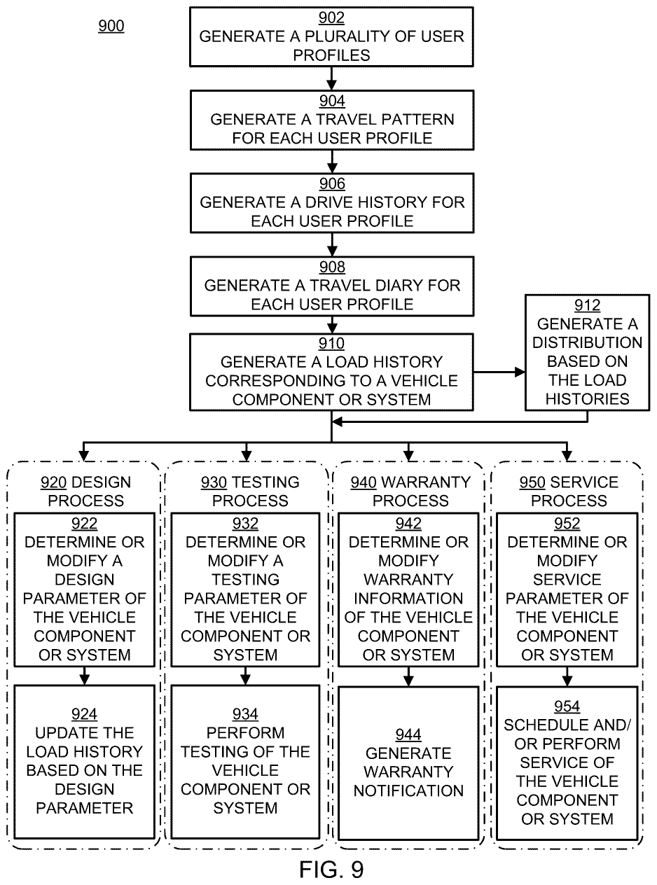

FIG. 9 is a flowchart of illustrative process 900 for generating and using travel diaries, in accordance with some embodiments of the present disclosure.

Step 902 includes generating a plurality of user profiles. The user profiles may correspond to simulated users, with attributes generated based on statistical information or other reference information. For example, a set of N user profiles may be generated, where N is statistically significant (e.g., to provide useful results in determining a load history distribution). Each user profile may include a metric value for one or more archetype metrics. The archetype metrics may include household size, age, activeness, risk-aversion, employment type/location, type of use (e.g., recreation, work, commuting), frequency of use, type of home charger, proximity to DCFC chargers, access to chargers and charger types, driving aggressiveness, nearby ground topology (e.g., country road, paved road, off-road), any other suitable metric, or any combination thereof. For example, step 902 may be performed by travel manager 110 of FIG. 1 or travel pattern generator 210 of FIG. 2. In a further example, step 902 may be performed by processing equipment and the user profiles may be stored in travel data 171 of FIG. 1 or travel data 271 of FIG. 2.

Step 904 includes generating a travel pattern for each user profile. Step 904 may include, for example, determining a set of events that occur sequentially based on a stochastic, multi-year model. For example, for each user, the corresponding travel pattern may include trips which occur with a respective start time, end time, duration, and character. For example, a trip may include departing home, driving along a path (e.g., which may include one or more road types), and arriving at a destination (e.g., a type such as a work location, store, mall, facility, vacation location, service location, or any other suitable destination type). For example, the travel pattern may span multiple years in order to build a drive history and load profile that may be used over a lifespan of a vehicle type. For example, step 904 may be performed by travel manager 110 of FIG. 1 or travel pattern generator 210 of FIG. 2.

Step 906 includes generating a drive history for each user profile, based on the travel pattern. In some embodiments, step 906 includes generating the drive history based on the travel pattern and drive cycle information. Step 906 may include, for example, applying a drive cycle from a library of reference drive cycles to each trip based on logical rules, stochastic rules (e.g., using reference distributions), chaining rules, or any other suitable criterion, to generate drive cycle information for each trip of each travel diary. The drive history may include, for each trip, an identifier of the drive cycle, number of repetitions (e.g., of a reference drive cycle), a mean trip speed, mean acceleration/deceleration, peak acceleration/deceleration, number of starts, number of stops, number of turns, a mean power consumption, a total energy consumption, a peak power, a distance, a road-type metric (e.g., paved, smooth, rough, off-road), any other suitable metric related to driving characteristics for a trip, or any combination thereof. For example, step 906 may be performed by driving manager 120 of FIG. 1 or drive cycle generator 220 of FIG. 2.

Step 908 includes generating a travel diary for each user profile. In some embodiments, step 908 may include process 500, for inserting charging events into each travel diary to result in travel diaries having trips and charging event information. The output of step 908 may be a set of N travel diaries for N synthetic users, each travel diary including a plurality of trips with corresponding trip information and a plurality of charging events with charging information. For example, step 908 may be completed by charging manager 130 of FIG. 1 or charging behavior generator 230 of FIG. 2, which insert charging events into the interim travel diaries output at step 906.

Step 910 includes generating a load history, for each travel diary, corresponding to a vehicle component or system based on the travel diaries. The load history may be generated for a component or system of the vehicle. For example, step 910 may include applying a load model, or a plurality of load models, to the travel diary to determine a cumulative load for each component or system. The cumulative load may include a cumulative value at each trip, or a single entry at the end of the vehicle life or otherwise predefined duration. Step 910 may also include applying a damage model, or a plurality of damage models, to the travel diary or load history to estimate a cumulative damage for each component or system.

Step 912 includes determining a distribution of a load parameter, a damage parameter, or both based on the plurality of load histories, corresponding to a vehicle component or system based on the travel diaries. The distribution may include a single value from each load history (e.g., a value for each travel diary or each user/vehicle), or a plurality of values. For example, the load parameter for each load history may include a single cumulative load determined at a predetermined time (e.g., the vehicle life, or other suitable span of time). To illustrate, a set of load parameters may be extracted from the load histories, corresponding to a set of times (e.g., each year), a set of loadings (e.g., each corresponding to a respective model), or a combination thereof. For example, step 912 may include using the results of the load model, or a plurality of load models, to determine a load parameter such as a cumulative load for each component or system. The cumulative load may include a cumulative value at each trip, or a single entry at the end of the vehicle life or otherwise predefined duration. The cumulative damage may include a cumulative value at each trip, or a single entry at the end of the vehicle life or otherwise predefined duration. In some embodiments, step 912 includes determining a plurality of distributions, each corresponding to a respective vehicle component or system (e.g., each having a corresponding load or damage model).

In an illustrative example, a load model may include an algorithm to determine force, torque, pressure, stress, strain, displacement, number of cycles, any other suitable parameter, or any combination thereof based on the drive cycle information for each trip. Accordingly, for each trip, of each travel diary, the system may apply the load model to determine a corresponding loading. At a predetermined end point, or lifespan, the cumulative loading may be collected for each of the N travel diaries and a distribution may be generated at step 912 to determine how the load has accumulated for each of the vehicles. Any number of suitable load models and damage models may be applied to the travel diaries to generate any suitable number of distributions. For example, for a set of travel diaries, load models for each suitable vehicle component or system may be applied to determine respective load histories and damage estimates. Processes 920, 930, 940, and 950, as discussed below, provide examples of how load histories may be used, in accordance with the present disclosure.

Process 920 is directed to design, and includes steps 922 and 924. Step 922 includes determining or modifying a design parameter of the vehicle component or system. For example, at step 922, a load history may be generated for each travel diary and a distribution may be generated. The distribution may include a percentage of vehicles with a cumulative load (e.g., a load value at the end of the vehicle life). Accordingly, the percentage of vehicles within a load threshold may be determined. Step 924 includes updating the load history based on the design parameter. For example, for a predetermine percentage threshold (e.g., 95%, 97%, or other suitable value), a design parameter may be updated in the load model or damage model at step 924, and the load histories may be updated based on the updated model. In a further example, the lifespan may be extended to achieve further load values. Accordingly, an iterative process 920 may applied to align a predetermine load value and a predetermined percentage. For example, the iterations may proceed until 95% of vehicles have a predetermined number of cycles, miles, actuations, (dis)charging cycles, or starts/stops, total load, damage metric value, wear metric value, any other suitable metric, or any combination thereof. In a further example, the iterations may proceed until 99% of vehicles reach a predetermined number of cycles, miles, actuations, (dis)charging cycles, or starts/stops, total load, damage metric value, wear metric value, any other suitable metric, or any combination thereof. In some embodiments, a distribution of values of a design parameter may be applied as part of the load model to generate a load history having a distribution of cumulative loadings. Accordingly, iteration need not be applied, and the distribution of cumulative loadings may be analyzed to determine the design parameter that best results in the target value (e.g., a percentage of vehicles threshold).

Process 930 is directed to testing, and includes steps 932 and 934. Step 932 includes determining or modifying a testing parameter of the vehicle component or system. Step 934 includes performing testing of the vehicle component or system. The distribution may include a percentage of vehicles with a cumulative load (e.g., a load value at the end of the vehicle life). Accordingly, a set of tests may be applied to predict failures, wear, damage, or other usage characteristics. Step 934 includes performing the testing on the vehicle component or system based on the testing parameter, which may include a force, torque, pressure, stress, strain, displacement, number of cycles, any other suitable parameter, any schedule or modulation thereof, or any combination thereof. The results of testing at step 934 may be used to refine the load model or damage model, which may be used at step 910 to iterate (e.g., for design process 920, which may be performed in concert with process 930).

Process 940 is directed to determining warranty information, and includes steps 942 and 944. Step 942 includes determining or modifying warranty information of the vehicle component or system. Step 944 includes generating a warranty notification regarding the vehicle component or system. For example, step 942 may include selecting a load or damage threshold based the load histories of step 910. For example, if a particular vehicle component or system is to be under warranty for a target number of miles or years, the load histories may be used to determine a distribution of damage or usage over time for the particular vehicle component or system. In order to align a target number of vehicles within a window corresponding to not having an expected warranty issue (e.g., having a load or damage metric less than a threshold), the time for the warranty may be adjusted to result in the target percentage, or process 920 may be used to modify a design such that the resulting distribution after step 910 achieves the target percentage. Accordingly, once the distribution results in an estimated target percentage of vehicles having less than a load or damage threshold, the warranty notification may be generated at step 944. For example, process 940 may be applied before sales to tune the vehicle design and warranty design based on the expected loading or damage of the vehicle component or system, as determined based on the load histories of step 910.

Process 950 is directed to managing vehicle servicing, and includes steps 952 and 954. Step 952 includes determining or modifying a service parameter of the vehicle component or system. For example, a servicing schedule may be determined for vehicle type, in which a set of servicing operations are to be performed at temporal or mileage milestones of vehicle usage. Step 954 includes scheduling, performing, or both service of the vehicle component or system (e.g., based on the servicing schedule). For example, step 952 may include selecting a load or damage threshold based the load histories of step 910. For example, if a particular vehicle component or system is to be serviced at a target number of miles or years, the load histories may be used to determine a distribution of damage or usage over time for the particular vehicle component or system. In order to align a target number of vehicles within a window corresponding to an expected servicing (e.g., having a load or damage metric less than or meeting a threshold), the time for the servicing may be adjusted to result in the target percentage, or process 920 may be used to modify a design such that the resulting distribution after step 910 achieves the target percentage. Accordingly, once the distribution results in an estimated target percentage of vehicles having less than a load or damage threshold, the servicing schedule may be determined, and servicing may be scheduled and performed at step 954. For example, process 9450 may be applied to tune the vehicle design and servicing schedule based on the expected loading or damage of the vehicle component or system, as determined based on the load histories of step 910.

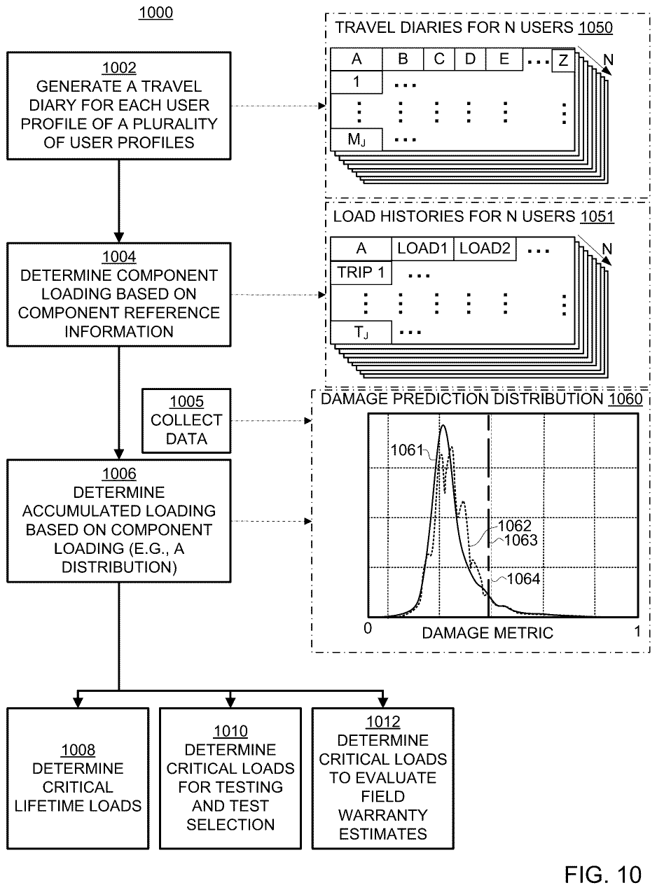

FIG. 10 is a flowchart of illustrative process 1000 for applying travel diaries to improve failure analysis, in accordance with some embodiments of the present disclosure.

Step 1002 includes generating a travel diary for each user profile of a plurality of user profiles. For example, step 1002 may correspond to steps 902-908 of process 900. Step 1002 may include generating N travel diaries, each include a respective plurality of trips, with drive cycles, and a plurality of charging events. In an illustrative example, at step 1002, for each of the N user profiles, the system may generate a plurality of entries (e.g., Mⱼ entries for user profile j). Panel 1050 illustrates that N travel diaries may be generated, with each including any suitable number of entries (e.g., some users may have fewer or greater entries than others). For each entry, the system may determine a plurality of corresponding information (e.g., along a row in panel 1050), illustrated with headings A-Z (e.g., although any suitable number of headings may be used). In some embodiments, for example, each travel diary is generated independently, and the ensemble is used to represent a plurality of real-world drivers and vehicles.

Step 1004 includes determining component loading based on component reference information and each travel diary. For each travel diary, corresponding to a respective user profile, a component loading may be determined. For example, each travel diary may include a load on the vehicle component and usage information. For example, the load may include a force (e.g., such as a shear force, bending force, tensile force, compressive force), a torque, a number of cycles, any other suitable indication of load, or any combination thereof. In a further example, for each trip of a travel diary, the vehicle speed, acceleration/deceleration, braking action, suspension action, electric current profile, voltage profile, temperature, thermal behavior (e.g., heat generation), number of cycles, may be determined and included in the travel diary. Accordingly, for each travel diary, a load history may be generated, including a multi-trip, multi-year history of loads applied to the vehicle component or system. The ensemble of all load histories then provides a rich set of information on which statistical analysis may be applied (e.g., at step 1006). In some embodiments, the component reference information may include a mode of use, mode of displacement, material properties, features, interfaces, any other suitable information corresponding to the component, or any combination thereof.

In an illustrative example, at step 1004, the system may generate, for each trip of each travel diary, a loading that my include a load (e.g., force, torque, stress, strain), number of cycles, any other suitable information that may correspond to failure or damage, or any combination thereof. Panel 1051 illustrates that N load histories may be generated, one for each travel diary, and each load history may include a total of Tⱼ trips for user j. For each trip of the T trips of each travel diary, the system may determine load metrics based on a model (e.g., a loading model, a dynamics model, a kinetic model, a lookup table, or any other suitable type of model). In some embodiments, in addition to trips (e.g., where the vehicle travels), the travel diary may also include charging events that may be included in the load history. For example, for vehicle components or systems that are used during charging such as the battery system and on-board charging system may be subject to loading (e.g., cycling) during charging, for which a use, wear, or damage model may be applied at step 1006.

Step 1006 includes determining accumulated loading based on the component loading of step 1004. The accumulated loading is based on the loading for each trip, for each vehicle. While a load history may include a temporal or event-based sequence of loadings, the accumulated loading represents a value at the end of the time or sequence, corresponding to a total wear at some time after significant use (e.g., at an end-of-lifespan, end of warranty span, or other terminal milestone). A damage model may be applied to the sequence of loadings to compute the accumulated loading or damage estimate. In some embodiments, step 1006 includes determining a single damage prediction for each vehicle (e.g., N values in total), based on a single loading mode and damage mode. In some embodiments, step 1006 includes determining D damage prediction values for each vehicle (e.g., D*N values in total), based on one or more loading modes and one or more damage modes. For example, the damage model may include a spalling model and a fracture model, or any other set of models corresponding to respective damage modes. In a further example, the damage model may include a thermal model to estimate temperatures, temperature differences, heat transfer rates, gradients, maximum or minimum values thereof, or any combination thereof. In a further example, the damage model may include an electrical model to estimate currents, voltages, voltage differences, power rates, resistances or impedances, maximum or minimum values thereof, or any combination thereof. In a further example, the damage model may include a flow model or fluid dynamics model to estimate pressures, pressure differences, corrosion, maximum or minimum values thereof, or any combination thereof. In a further example, a model may include a multi-physics model that may include aspects of electromagnetics, heat transfer, fluid dynamics, solid dynamics, surface chemistry, any other suitable physical or chemical phenomena, or any combination thereof.

In an illustrative example, at step 1006, the system may determine for each load history, for each user profile, a damage metric. Panel 1060 illustrates that, based on the N load histories, and a damage model, a distribution of damage metrics may be generated (e.g., having N data points). For example, in some embodiments, for each load history, the system may determine a damage metric correspond to a respective damage mode, and then generate a distribution of damage based on the N metrics (e.g., one for each travel diary and corresponding load history). Each metric may be a representative accumulated value corresponding to a column of the table of panel 1051. For example, a distribution similar to that illustrated in panel 1060 may be generated for each load metric (e.g., each column) of the table of panel 1051. In a further example, a distribution similar to that illustrated in panel 1060 may be generated based on a plurality of load metrics (e.g., several columns) of the table of panel 1051. To illustrate, the distribution may include a value of the damage metric at a vehicle lifespan or other suitable reference time. The time may be specified, and the damage metric corresponding to the time may be extracted for each damage prediction and combined in aggregate to form the distribution (e.g., distribution 1061, as illustrated). In some embodiments, data collected at step 1005 (e.g., validation data from vehicles in the field corresponding to the vehicle type) may be used to validate the loading model, damage model, or both (e.g., to tune the models). For example, distribution 1062 may be generated based on the data collected at step 1005. In some embodiments, as illustrated, a 95-percentile damage estimate may be generated for the modeled data (e.g., estimate 1063) and for the collected data (e.g., estimate 1064), and compared to validate the load and damage models. The illustrative distributions of panel 1060 may similarly be generated for any suitable damage prediction, optionally incorporating any suitable validation data. Based on analysis of the distribution determined at step 1006, design, testing, servicing, or warranty actions may be determined or modified. For example, for a target loading, the system may determine a subset of load histories achieving the target (e.g., a fraction of the travel diaries).

At step 1008, the system determines critical lifetime loads to design for durability, for example. In some embodiments, the system may identify a Nth-percentile (e.g., 95%, or any other suitable target) damage estimate, and validate or modify a design parameter of the vehicle component or system. For example, process 1000 may be iterated to determine an optimized design parameter. The design parameter may include a material selection, thickness, diameter, width, length, cross-section, angle, shape, contour, feature characteristic, any other suitable dimension or composition aspect, or any combination thereof. For example, a diameter or taper of a half-shaft of a vehicle drivetrain may be determined based on an iterative application of process 1000.

At step 1010, the system determines critical lifetime loads for testing and test selection, for example. In some embodiments, the system may identify a test type and test conditions to subject the vehicle component or system to in order to validate a model. The load histories generated at step 1004, or damage prediction determined at step 1006, may be used to tailor the testing process. For example, process 1000 may be iterated to determine an optimized design parameter. The testing parameter may include a duration, testing loading, number of cycles, variation in loading, any other suitable aspect of testing the component or system, or any combination thereof. For example, test conditions may be determined based on an iterative application of process 1000.

At step 1012, the system determines critical lifetime loads to evaluate field warranty estimates, for example. In some embodiments, the system may identify a reliability target of the vehicle component or system. For example, process 1000 may be iterated to determine optimized warranty information. The warranty information may include a time period, a failure or damage mode, an expected failure rate (e.g., based on the damage prediction), any other suitable information corresponding to a use life of components and replacement thereof, or any combination thereof. For example, a warranty information may be determined, or modified, based on an iterative application of process 1000.

In an illustrative example, the system may generate a plurality of travel diaries (e.g., at step 908 or step 1002) based on a plurality of synthetic user profiles. The travel diaries may be based on part on travel patterns that may include travel route information (e.g., number of turns, severity of turns), driving style (e.g., speed over time or mean speed, peak acceleration/deceleration, mean acceleration/deceleration), or a combination thereof, which may be inputted to a vehicle propulsion model (e.g., at step 906 or step 1004). The vehicle propulsion model may output a load such as a torque and joint angle for a vehicle half-shaft, for each trip over the entire vehicle life from the travel diary. The half-shaft may connect a gearbox to a wheel, and spalling may occur based on torque, steering angle, and ride height (e.g., how aggressively the vehicle is driven). A damage model maybe applied to the outputted load to estimate damage from each trip, for each vehicle. For example, referencing a vehicle half-shaft, the damage model may include a spalling damage model, which may be applied to each trip, to result in an accumulated half-shaft spalling damage prediction for each travel diary (e.g., for each vehicle of the set of N vehicles of N users). Based on the accumulated damage prediction generated at step 1006, for each load history, the system may determine thresholds for damage over the vehicle life. For example, by specifying a percentage (e.g., 90%, 95%, 99%, or any other suitable threshold) corresponding to the accumulated damage prediction (e.g., the distribution of the accumulated damage prediction over the N vehicles), a quantitative damage estimate may be determined. In a further example, the design may be tuned by iterating process 1000, such that the percentage aligns with a target damage metric value (e.g., by tuning the distribution).

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A method comprising:
generating, using processing equipment, a travel diary for each user profile of a plurality of user profiles based on a plurality of travel patterns, drive cycle information of a vehicle type, and charging information to result in a plurality of travel diaries;
generating a plurality of load histories corresponding to a vehicle component of the vehicle type based on the plurality of travel diaries;
generating a distribution of a load parameter based on the plurality of load histories; and
determining, using the processing equipment, vehicle information based on the distribution of the load parameter.

2. The method of claim 1, further comprising generating, based on the plurality of load histories, a design parameter for the vehicle component.

3. The method of claim 1, further comprising generating, based on the plurality of load histories, a testing parameter for the vehicle component.

4. The method of claim 1, further comprising generating, based on the plurality of load histories, a servicing parameter for the vehicle component.

5. The method of claim 1, further comprising modifying, based on the plurality of load histories, at least one of (i) a design parameter of the vehicle component or (ii) a testing parameter of the vehicle component.

6. The method of claim 1, further comprising:
determining, based on the plurality of load histories, warranty information corresponding to the vehicle component, wherein the warranty information comprises a target warranty life of the vehicle type, and wherein each of the plurality of travel diaries spans the target warranty life; and
generating a warranty notification based on the warranty information.

7. The method of claim 1, further comprising:
determining, using the processing equipment, a remaining life of the vehicle component based on the plurality of load histories; and
generating an indication of the remaining life at a user interface.

8. The method of claim 1, further comprising updating, in memory storage of a vehicle of the vehicle type, a threshold value corresponding to the plurality of load histories.

9. The method of claim 1, further comprising:
receiving updated information corresponding to the vehicle component; and
updating the plurality of load histories based on the updated information.

10. The method of claim 1, further comprising generating a damage distribution based on the plurality of load histories and a damage model.

11. The method of claim 1, wherein each travel diary comprises a respective plurality of trips, and wherein generating the plurality of load histories comprises applying a load model to each respective plurality of trips.

12. The method claim 1, further comprising determining the plurality of user profiles based on a plurality of predetermined user archetypes corresponding to a target customer base.

13. The method of claim 1, further comprising generating the plurality of travel patterns based on a stochastic, multi-year model.

14. The method of claim 1, wherein the plurality of user profiles is a first plurality of user profiles, the method further comprising:
determining a second plurality of user profiles; and
repeating generating the travel diary for each user profile and generating the plurality of load histories based on the second plurality of user profiles.

15. The method of claim 1, wherein generating the travel diary for each user profile of the plurality of user profiles comprises:
generating a travel pattern for each user profile to result in the plurality of travel patterns corresponding to the vehicle type;
generating a drive history for each user profile based on the plurality of travel patterns and based on the drive cycle information to result in a plurality of drive histories; and
generating the charging information based on the travel pattern and the drive history for each user profile.

16. The method of claim 1, further comprising:
identifying a subset of user profiles of the plurality of user profiles corresponding to an attribute, wherein a subset of travel diaries of the plurality of travel diaries correspond to the subset of user profiles;
identifying a target stress corresponding to the vehicle component based on the subset of travel diaries; and
determining at least one of a design parameter, a testing parameter, a service parameter, or a warranty parameter based on the target stress.

17. A system comprising:
processing equipment configured to:
generate a travel diary for each user profile of a plurality of user profiles based on a plurality of travel patterns, drive cycle information of a vehicle type, and charging information to result in a plurality of travel diaries;
generate a plurality of load histories corresponding to a vehicle component of the vehicle type based on the plurality of travel patterns;
generate a distribution of a load parameter based on the plurality of load histories; and
determine vehicle information based on the distribution of the load parameter.

18. The system of claim 17, wherein the processing equipment is further configured to generate the travel diary for each user profile of the plurality of user profiles by:
generating a travel pattern for each user profile to result in the plurality of travel patterns corresponding to the vehicle type;
generating a drive history for each user profile based on the plurality of travel patterns and based on the drive cycle information to result in a plurality of drive histories; and
generating the charging information based on the travel pattern and the drive history for each user profile.

19. A non-transitory computer-readable medium having instructions encoded thereon that when executed by processing equipment cause the processing equipment to:
generate a travel diary for each user profile of a plurality of user profiles based on a plurality of travel patterns, drive cycle information of a vehicle type, and charging information to result in a plurality of travel diaries;
generate a plurality of load histories corresponding to a vehicle component of the vehicle type based on the plurality of travel patterns;
generate a distribution of a load parameter based on the plurality of load histories; and
determine vehicle information based on the distribution of the load parameter.

20. The non-transitory computer-readable medium of claim 19, further comprising instructions that cause the processing equipment to generate the travel diary for each user profile of the plurality of user profiles by:
generating a travel pattern for each user profile to result in the plurality of travel patterns corresponding to the vehicle type;
generating a drive history for each user profile based on the plurality of travel patterns and based on the drive cycle information to result in a plurality of drive histories; and
generating the charging information based on the travel pattern and the drive history for each user profile.
